(19) United States
(12) Patent Application Publication
(10) Pub. No.: US 2013/0249946 A1
(43) Pub. Date: Sep. 26, 2013

(54) HEAD-MOUNTED DISPLAY DEVICE

(71) Applicant: SEIKO EPSON CORPORATION, Tokyo (JP)

(72) Inventor: Fusashi Kimura, Matsumoto-shi (JP)

(73) Assignee: SEIKO EPSON CORPORATION, Tokyo (JP)

(21) Appl. No.: 13/831,916

(22) Filed: Mar. 15, 2013

(30) Foreign Application Priority Data
Mar. 22, 2012 (JP) 2012-064730

(51) Int. Cl. G06T 5/50

(52) U.S. Cl. CPC G06T 5/50
USPC 345/633

(57) ABSTRACT

Ahead-mounted display device includes: an image display unit including an image light generating unit that generates image light representing an image and a light guide unit that guides the image light to the eyes of a user, and allowing the user to visually recognize a virtual image in a state where the image display unit is mounted on the head of the user; a detecting unit that is disposed in the image display unit and detects at least one of an impact and displacement; and a control unit that generates a given command based on detection data detected in the detecting unit.

### BACKGROUND

1. Technical Field

The present invention relates to a head-mounted display device that allows a user to visually recognize a virtual image in a state where the head-mounted display device is mounted on the head of the user.

2. Related Art

In the related art, head-mounted display devices that allow a user to visually recognize a virtual image in a state where the head-mounted display device is mounted on the head of the user, like head-mounted displays, have been known. In such head-mounted display devices, a see-through head-mounted display device that superimposes a virtual image on an outside world image has been proposed (for example, refer to JP-A-2006-3879).

The head-mounted display device usually has an image display unit that allows a user to visually recognize a virtual image in a state where the image display unit is mounted on the head of the user and a controller that controls the image display unit. However, such a head-mounted display device has a problem in that it is difficult to perform a device operation such as a button operation of the controller, irrespective of the see-through type or a closed type that does not superimpose a virtual image on an outside world image.

### SUMMARY

An advantage of some aspects of the invention can provide a head-mounted display device in which a device operation can be easily performed.

(1) A head-mounted display device according to an aspect of the invention includes: an image display unit including an image light generating unit that generates image light representing an image, and allowing a user to visually recognize a virtual image in a state where the image display unit is mounted on the head of the user; a detecting unit that detects at least one of an impact and displacement; and a control unit that generates a given command based on detection data detected in the detecting unit.

In the aspect of the invention, the detecting unit may be disposed in the image display unit or may be disposed in the control unit. Moreover, the control unit may be configured separately from the image display unit, or the control unit and the image display unit may be integrally configured.

According to the aspect of the invention, the head-mounted display device is configured such that the detecting unit that detects at least one of an impact and displacement is disposed in the image display unit mounted on the head of the user or the control unit, and that a given command is generated based on detection data detected in the detecting unit, so that a device operation can be performed by a simple operation such as giving an impact or displacement to the image display unit mounted on the head of the user or the control unit (for example, the user taps the image display unit or the control unit with his/her finger).

(2) In the head-mounted display device, the detecting unit may be disposed in the image display unit.

According to this configuration, the head-mounted display device is configured such that the detecting unit that detects at least one of an impact and displacement is disposed in the image display unit mounted on the head of the user, and that a given command is generated based on detection data detected in the detecting unit, so that a device operation can be performed by a simple operation such as giving an impact or displacement to the image display unit mounted on the head of the user (for example, the user taps the image display unit with his/her finger).

(3) In the head-mounted display device, the image display unit may be configured such that the user can visually recognize the virtual image and an outside world image simultaneously, and the control unit may control, based on detection data detected in the detecting unit, image display with the image light generating unit to adjust the luminance of the image light.

According to this configuration, it is possible to perform an operation of changing the easiness of visual recognition of each of the virtual image and the outside world image by a simple operation such as giving an impact or displacement to the image display unit mounted on the head of the user (for example, the user taps the image display unit with his/her finger).

(4) In the head-mounted display device, the control unit may perform, based on detection data detected in the detecting unit, control of switching between a mode where the user is allowed to visually recognize the virtual image and an outside world image simultaneously and a mode where the luminance of the image light is lowered to allow the user to visually recognize the outside world image preferentially.

According to this configuration, in a see-through head-mounted display device, it is possible to perform the operation of switching between the mode where the virtual image and the outside world image are visually recognized simultaneously and the mode where the outside world image is visually recognized preferentially, by a simple operation such as giving an impact or displacement to the image display unit mounted on the head of the user or the control unit (for example, the user taps the image display unit or the control unit with his/her finger).

(5) In the head-mounted display device, the control unit may generate the command based on at least one of the number and direction of impacts detected in the detecting unit.

According to this configuration, it is possible to perform a device operation by a simple operation such as giving an impact to the image display unit mounted on the head of the user or the control unit (for example, the user taps the image display unit or the control unit with his/her finger). Further, it is possible to generate a command that is different according to the number and direction of impacts given to the image display unit or the control unit (for example, the number of times and direction by the user tapping the image display unit or the control unit with his/her finger).

(6) In the head-mounted display device, the detecting unit may include a plurality of sensors that detect at least one of an impact and displacement.

According to this configuration, the detecting unit includes a plurality of sensors that detect at least one of an impact and displacement, so that the detection accuracy can be improved.

(7) In the head-mounted display device, the detecting unit may include an acceleration sensor and an angular velocity sensor.

According to this configuration, the detecting unit includes an acceleration sensor and an angular velocity sensor, so that the detection accuracy can be improved.

(8) In the head-mounted display device, the control unit may be disposed in the image display unit.

### BRIEF DESCRIPTION OF THE DRAWINGS

The invention will be described with reference to the accompanying drawings, wherein like numbers reference like elements.

FIG. 1 is an external view showing an example of the configuration of a head-mounted display device according to an embodiment.

FIG. 2 is a functional block diagram functionally showing the configuration of the head-mounted display device according to the embodiment.

FIG. 3 is an explanatory view showing an example of a virtual image visually recognized by a user.

FIG. 4 is an explanatory view showing an example of operations on the head-mounted display device.

FIGS. 5A to 5C each show an example of detection data output from a detecting unit.

FIGS. 6A and 6B each show an example of detection data output from the detecting unit.

FIG. 7 shows an example of commands each allocated to the direction and number of impacts detected in the detecting unit.

FIG. 8 explains a modified example.

### DESCRIPTION OF EXEMPLARY EMBODIMENTS

Hereinafter, a preferred embodiment of the invention will be described in detail with reference to the drawings. The embodiment described below does not unduly limit the contents of the invention set forth in the appended claims. Moreover, not all of the configurations described below are necessarily indispensable constituent features of the invention.

### 1. Configuration

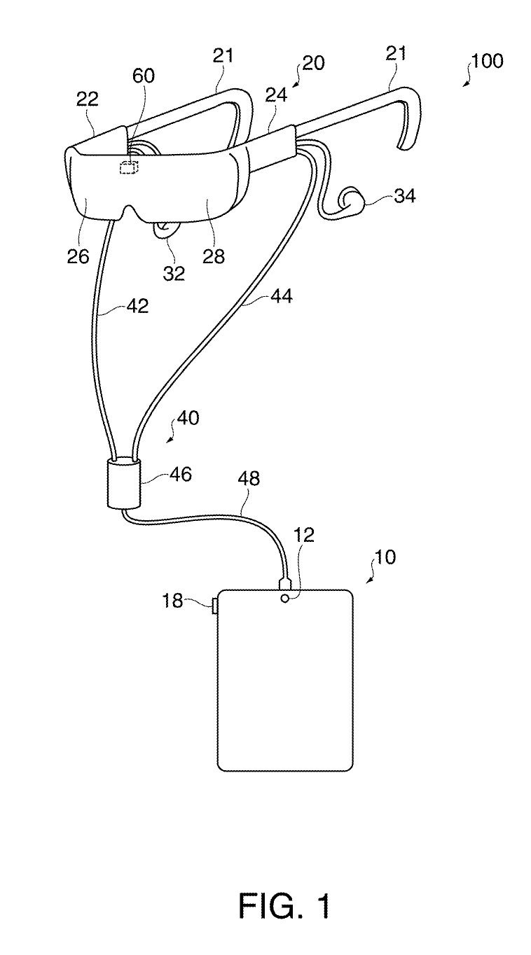

FIG. 1 is an external view showing an example of the configuration of a head-mounted display device according to the embodiment.

The head-mounted display device 100 is a display device to be mounted on the head and also called a head-mounted display (HMD). The head-mounted display device 100 of the embodiment is an optically transmissive (so-called see-through) head-mounted display device with which a user can visually recognize a virtual image and, at the same time, visually recognize directly an outside scene (outside world image).

The head-mounted display device 100 includes an image display unit 20 that allows a user to visually recognize a virtual image in a state where the image display unit 20 is mounted on the head of the user and a control unit 10 that controls the image display unit 20.

The image display unit 20 is a mounted body to be mounted on the head of the user and has an eyeglasses shape in the embodiment. The image display unit 20 includes ear hook units 21, a right display driving unit 22, a left display driving unit 24, a right optical image display unit 26, and a left optical image display unit 28. Moreover, a detecting unit 60 (sensor) that detects at least one of an impact and displacement is disposed in the image display unit 20. The ear hook units 21 are members disposed so as to transverse on the ears of the user from ends of the right display driving unit 22 and the left display driving unit 24, and function as temples. The right optical image display unit 26 and the left optical image display unit 28 are arranged so as to be located in front of the right and left eyes of the user, respectively, in the state where the user wears the image display unit 20. The right display driving unit 22 is arranged at a connecting portion of the ear hook unit 21 for the right ear and the right optical image display unit 26. Moreover, the left display driving unit 24 is arranged at a connecting portion of the ear hook unit 21 for the left ear and the left optical image display unit 28. In the following, the right display driving unit 22 and the left display driving unit 24 are collectively referred to as simply “display driving unit”, and the right optical image display unit 26 and the left optical image display unit 28 are collectively referred to as simply “optical image display unit”.

The display driving unit includes a driving circuit, an LCD (liquid crystal display), and a projection optical system (not shown). The optical image display unit includes a light guide plate and a light modulating plate (not shown). The light guide plate is formed of a light transmissive resin material or the like and allows image light captured from the display driving unit to exit toward the eyes of the user. The light modulating plate is a thin plate-like optical element and arranged so as to cover the front side (the side opposed to the user's eye side) of the image display unit 20. The light modulating plate protects the light guide plate and prevents the damage, adhesion of dirt, or the like to the light guide plate. Also, the light modulating plate adjusts the light transmittance of the light modulating plate to thereby adjust the amount of external light entering the eyes of the user, so that the easiness of visual recognition of a virtual image can be adjusted. The light modulating plate can be omitted.

The image display unit 20 further has a right earphone 32 for the right ear and a left earphone 34 for the left ear. The right earphone 32 and the left earphone 34 are mounted in the right and left ears, respectively, when the user wears the image display unit 20.

The image display unit 20 further includes a connecting unit 40 for connecting the image display unit 20 to the control unit 10. The connecting unit 40 includes a main body cord 48 connected to the control unit 10, a right cord 42 and a left cord 44 that are two cords branching from the main body cord 48, and a coupling member 46 disposed at the branch portion. The right cord 42 is connected to the right display driving unit 22, while the left cord 44 is connected to the left display driving unit 24. The image display unit 20 and the control unit 10 perform transmission of various kinds of signals via the connecting unit 40. Connectors (not shown) that fit with each other are respectively disposed at an end of the main body cord 48 on the side opposed to the coupling member 46 and at the control unit 10. The control unit 10 and the image display unit 20 can be connected or disconnected by fitting the connector of the main body cord 48 with the connector of the control unit 10 or releasing the fitting. For the main body cord 48, the right cord 42, and the left cord 44, a metal cable or an optical fiber can be adopted.

The control unit 10 is a device for supplying power to the head-mounted display device 100 and controlling the image display unit 20. The control unit 10 includes a lighting unit 12 and a power switch 18. The lighting unit 12 notifies the user of an operation state (for example, the ON or OFF state of a power supply) of the image display unit 20 through the light emission state of the lighting unit. As the lighting unit 12, a light source such as an LED can be used. The power switch 18 detects a slide operation of the switch to switch the power-on state of the head-mounted display device 100.

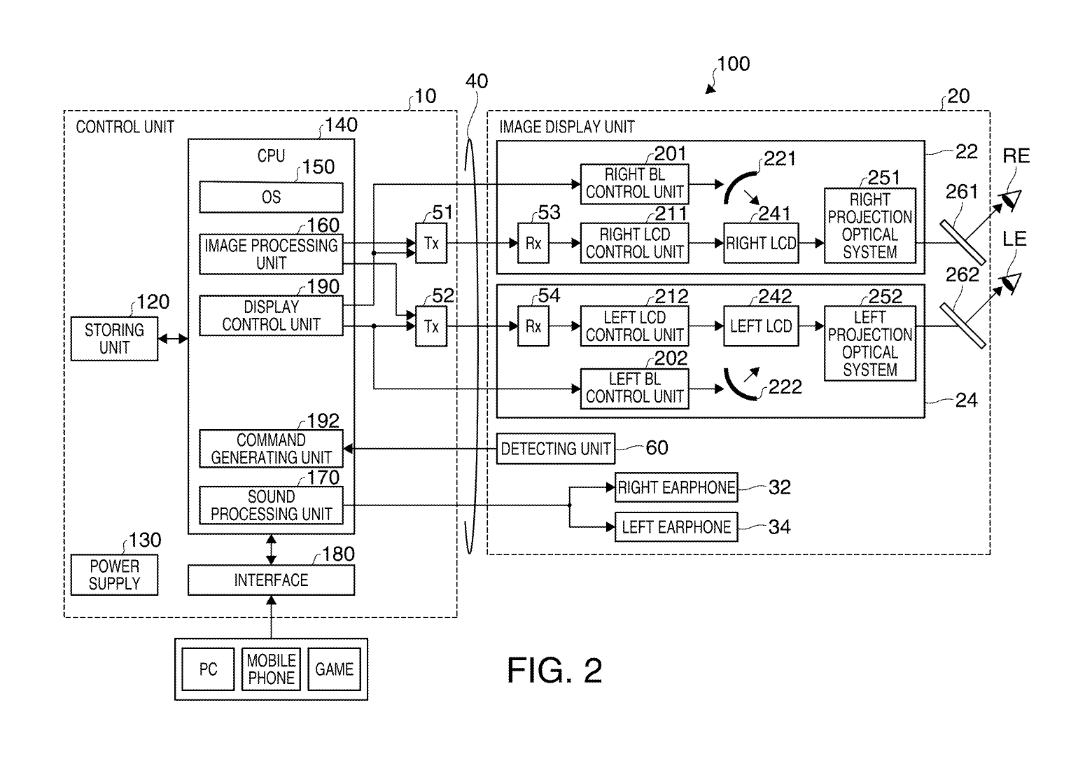

FIG. 2 is a functional block diagram functionally showing the configuration of the head-mounted display device 100. The control unit 10 includes a storing unit 120, a power supply 130, a CPU 140, an interface 180, and transmitting units (Tx) 51 and 52. The units are connected to one another by a bus (not shown).

The storing unit 120 is a storing unit including a ROM, a RAM, a DRAM, and a hard disk. The power supply 130 supplies power to the units of the head-mounted display device 100. As the power supply 130, a secondary battery, for example, can be used.

The CPU 140 executes a program installed in advance to provide a function as an operating system (OS) 150. Moreover, the CPU 140 expands firmware or a computer program stored in the ROM or the hard disk on the RAM and executes the firmware or the computer program to thereby function also as an image processing unit 160, a sound processing unit 170, a display control unit 190, and a command generating unit 192.

The interface 180 is an interface for connecting various kinds of external apparatuses OA (for example, a personal computer (PC), a mobile-phone terminal, and a game terminal) serving as supply sources of contents to the control unit 10. As the interface 180, the control unit 10 includes, for example, a USB interface, an interface for memory card, and a wireless LAN interface. The contents mean information contents including an image (a still image or a moving image) and sound.

The image processing unit 160 generates, based on contents input via the interface 180, a clock signal, a vertical synchronizing signal, a horizontal synchronizing signal, and image data, and supplies these signals to the image display unit 20 via the connecting unit 40. Specifically, the image processing unit 160 acquires image signals included in the contents. For example, in the case of a moving image, the acquired image signals are generally analog signals including 30 frame images per second. The image processing unit 160 separates synchronizing signals such as a vertical synchronizing signal and a horizontal synchronizing signal from the acquired image signals. Moreover, the image processing unit 160 generates a clock signal using a PLL circuit (not shown) or the like according to periods of the separated vertical synchronizing signal and horizontal synchronizing signal.

The image processing unit 160 converts the analog signals from which the synchronizing signals are separated into digital image signals using an A/D converter (not shown). Thereafter, the image processing unit 160 stores the converted digital image signals, as image data (RGB data) of a target image, in the DRAM in the storing unit 120 frame by frame. The image processing unit 160 may execute on the image data, as necessary, image processing such as resolution conversion processing, various kinds of color tone correction processing including the adjustment of luminance and chroma, or keystone correction processing.

The image processing unit 160 transmits the generated clock signal, the vertical synchronizing signal, the horizontal synchronizing signal, and the image data stored in the DRAM in the storing unit 120 via each of the transmitting units 51 and 52. The image data transmitted via the transmitting unit 51 is referred to as “image data for the right eye”, while the image data transmitted via the transmitting unit 52 is referred to as “image data for the left eye”. The transmitting units 51 and 52 each function as a transceiver for serial transmission between the control unit 10 and the image display unit 20.

The display control unit 190 generates control signals for controlling the right display driving unit 22 and the left display driving unit 24. Specifically, the display control unit 190 separately controls, according to the control signals, turning on and off of driving of a right LCD 241 with a right LCD control unit 211, turning on and off of driving of a right backlight 221 with a right backlight control unit 201, turning on and off of driving of a left LCD 242 with a left LCD control unit 212, and turning on and off of driving of a left backlight 222 with a left backlight control unit 202, to thereby control the generation and emission of image light with each of the right display driving unit 22 and the left display driving unit 24.

The display control unit 190 transmits control signals for the right LCD control unit 211 and the left LCD control unit 212 respectively via the transmitting units 51 and 52. Moreover, the display control unit 190 transmits control signals for the right backlight control unit 201 and the left backlight control unit 202 respectively via the transmitting units 51 and 52.

The command generating unit 192 acquires detection data from the detecting unit 60 disposed in the image display unit 20 via the connecting unit 40, and generates a given command based on the acquired detection data (detection data obtained by converting analog signals output from the detecting unit 60 into digital signals using an A/D converter (not shown)). The command generating unit 192 may generate, as the given command, for example a command for allowing the display control unit 190 to perform display control such as the turning on and off of driving of the right LCD 241 and the left LCD 242 or the turning on and off of driving of the right backlight 221 and the left backlight 222, or a command for allowing the image processing unit 160 to perform given image processing. For example, the command generating unit 192 may generate, based on detection data from the detecting unit 60, a command to control the turning on and off of driving of the right backlight 221 and the left backlight 222 or the turning on and off of driving of the right LCD 241 and the left LCD 242 to control the display control unit 190, to thereby perform control of adjusting the luminance of image light.

Moreover, the command generating unit 192 may generate commands to control various kinds of applications (such as an application for reproducing a moving image and sound, an application for game, an application for Web browsing, an application for e-mail, or a GUI application for providing a menu screen or the like) installed in the OS 150. For example, the command generating unit 192 may generate, based on detection data from the detecting unit 60, a command to perform reproduction control of the application for reproducing a moving image and sound, or a command to operate the application for Web browsing, the application for e-mail, or a menu screen to thereby control the OS 150 (or an application).

Moreover, the command generating unit 192 may detect, based on detection data from the detecting unit 60, at least one of the number and direction of impacts detected in the detecting unit 60, and generate a command according to at least one of the detected number and direction. For example, the command generating unit 192 may generate a command that is different according to the number of impacts detected in a predetermined time, may generate a command that is different according to the direction (for example, any direction of the positive X-axis direction, the negative X-axis direction, the positive Y-axis direction, the negative Y-axis direction, the positive Z-axis direction, and the negative Z-axis direction, when the detecting unit 60 includes a three-axis acceleration sensor) of the detected impact, or may generate a command that is different according to a combination of the number and direction of the detected impacts.

The sound processing unit 170 acquires sound signals included in the contents, amplifies the acquired sound signals, and supplies the sound signals to the right earphone 32 and the left earphone 34 of the image display unit 20 via the connecting unit 40.

The image display unit 20 includes the right display driving unit 22, the left display driving unit 24, a right light-guide plate 261 constituting the right optical image display unit 26, a left light-guide plate 262 constituting the left optical image display unit 28, the detecting unit 60, the right earphone 32, and the left earphone 34.

The right display driving unit 22 includes a receiving unit (Rx) 53, the right backlight (BL) control unit 201 and the right backlight 221 that function as alight source, the right LCD control unit 211 and the right LCD 241 that function as a display element, and a right projection optical system 251. The right backlight control unit 201, the right LCD control unit 211, the right backlight 221, and the right LCD 241 are collectively referred to as “image light generating unit”.

The receiving unit 53 functions as a receiver for serial transmission between the control unit 10 and the image display unit 20. The right backlight control unit 201 has a function of driving the right backlight 221 based on an input control signal. The right backlight 221 is, for example, a luminant such as an LED or an electroluminescence (EL). The right LCD control unit 211 has a function of driving the right LCD 241 based on the clock signal, vertical synchronizing signal, horizontal synchronizing signal, and image data for the right eye input via the receiving unit 53. The right LCD 241 is a transmissive liquid crystal panel having a plurality of pixels arranged in a matrix. The image light generating unit has a function of driving liquid crystals corresponding to the positions of the pixels arranged in a matrix in the right LCD 241 to thereby change the transmittance of light transmitting through the right LCD 241 to modulate illumination light irradiated from the right backlight 221 into effective image light representing an image. In the image light generating unit of the embodiment, a backlight system is adopted. However, a configuration may be adopted in which image light is generated using a frontlight system or a reflecting system. The right projection optical system 251 includes a collimate lens that converts image light emitted from the right LCD into light beams in a parallel state. The right light-guide plate 261 guides the image light emitted from the right projection optical system 251 to a right eye RE of the user while reflecting the image light along a predetermined optical path. The right projection optical system 251 and the right light-guide plate 261 are collectively referred to as “light guide unit”.

The left display driving unit 24 includes a receiving unit (Rx) 54, the left backlight (BL) control unit 202 and the left backlight 222 that function as a light source, the left LCD control unit 212 and the left LCD 242 that function as a display element, and a left projection optical system 252. The left backlight control unit 202, the left LCD control unit 212, the left backlight 222, and the left LCD 242 are collectively referred to as “image light generating unit”. Moreover, the left projection optical system 252 and the left light-guide plate 262 are collectively referred to as “light guide unit”. The right display driving unit 22 and the left display driving unit 24 form a pair. The units of the left display driving unit 24 have configurations and functions similar to those of the units described in conjunction with the right display driving unit 22, and therefore detailed descriptions are omitted. The left light-guide plate 262 guides image light emitted from the left projection optical system 252 to a left eye LE of the user while reflecting the image light along a predetermined optical path.

The detecting unit 60 detects at least one of an impact and displacement and outputs detection data to the command generating unit 192 via the connecting unit 40. The detecting unit 60 includes at least one inertial sensor such as an acceleration sensor that detects acceleration or an angular velocity sensor (gyro sensor) that detects angular velocity. For example, the detecting unit 60 may include only an acceleration sensor or a combination of an acceleration sensor and an angular velocity sensor.

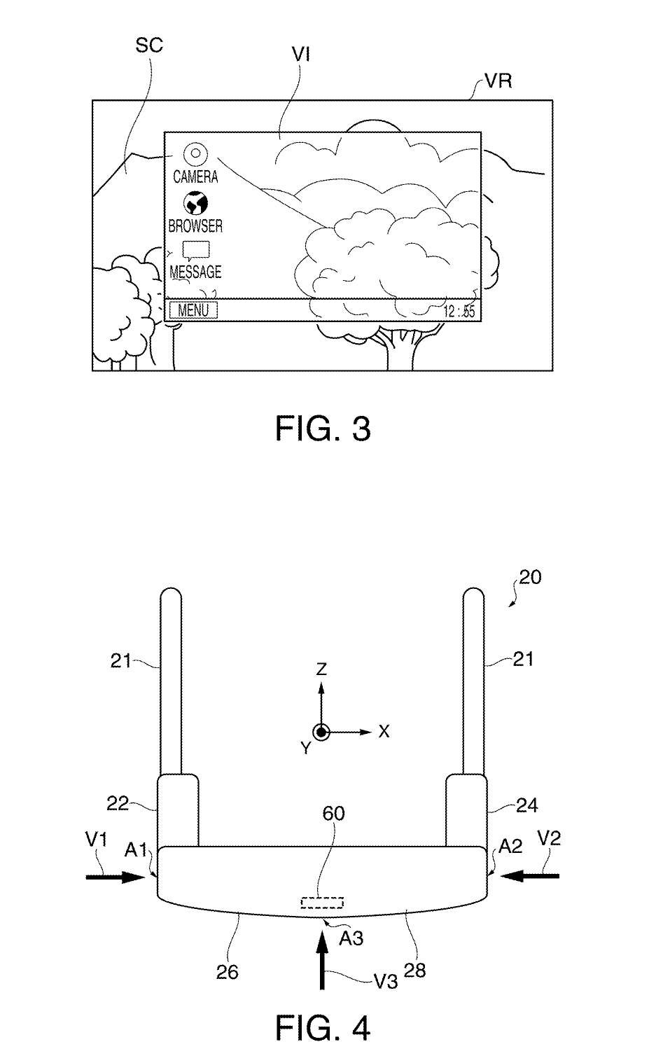

FIG. 3 is an explanatory view showing an example of a virtual image visually recognized by the user. The image lights guided to the eyes of the user wearing the head-mounted display device 100 as described above are focused on the retinas of the eyes of the user, whereby the user can visually recognize a virtual image. As shown in FIG. 3, a virtual image VI is displayed in a visual field VR of the user of the head-mounted display device 100. In the visual field VR of the user except a portion where the virtual image VI is displayed, the user can see an outside scene SC (outside world image) through the right optical image display unit 26 and the left optical image display unit 28. The head-mounted display device 100 of the embodiment is configured such that in the portion where the virtual image VI is displayed in the visual field VR of the user, the user can also see the outside scene SC through the virtual image VI in the background of the virtual image VI. That is, the head-mounted display device 100 of the embodiment is configured such that the user can visually recognize the virtual image VI and the outside scene SC (outside world image) simultaneously, and that in the portion where the virtual image VI is displayed in the visual field VR, the user can visually recognize the virtual image VI and the outside scene SC (outside world image) in a state where they are superimposed on each other.

### 2. Method of Embodiment

As shown in FIG. 4, the head-mounted display device 100 of the embodiment is configured such that the detecting unit 60 is disposed in the image display unit 20, that when the user performs with his/her finger an operation of lightly tapping any portion of the image display unit 20 mounted on the head, the detecting unit 60 detects the impact, and that the command generating unit 192 generates a command based on detection data from the detecting unit 60.

The detecting unit 60 of the embodiment includes a three-axis acceleration sensor. The three axes (the X-, Y-, and Z-axes) of the acceleration sensor are arranged so as to respectively coincide with the horizontal direction, vertical direction, and depth direction (the X-axis, Y-axis, and Z-axis in the drawing) of the image display unit 20.

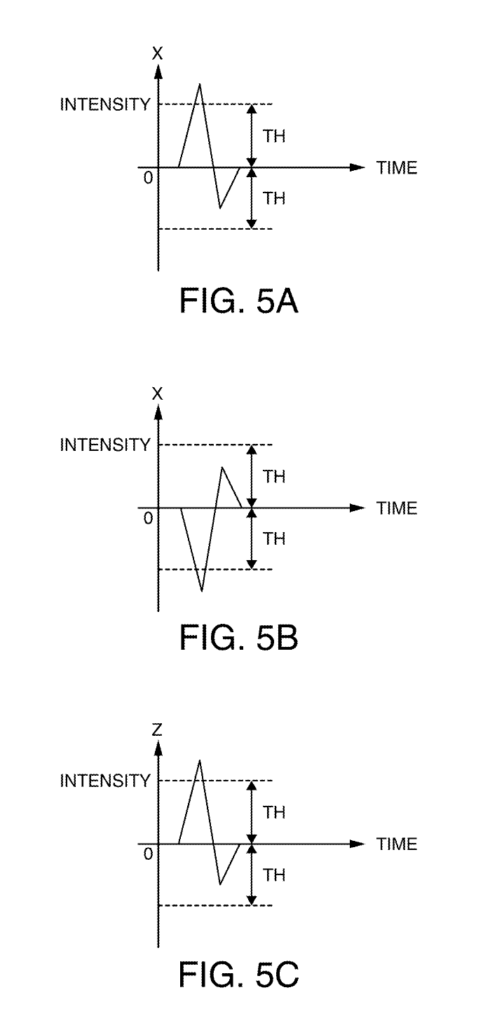

For example, in FIG. 4, when the user taps a right-side end portion A1 of the right optical image display unit 26 only once with his/her finger from a direction indicated by V1 in the drawing, acceleration in the positive X-axis direction is generated, and detection data shown in FIG. 5A is output from the detecting unit 60. In this case, the command generating unit 192 detects in the detection data from the detecting unit 60 that the acceleration in the positive X-axis direction exceeds a predetermined threshold value TH once, and generates a command corresponding to one impact in the positive X-axis direction assuming that there is one impact in the positive X-axis direction.

Moreover, in FIG. 4, when the user taps a left-side end portion A2 of the left optical image display unit 28 with his/her finger only once from a direction indicated by V2 in the drawing, acceleration in the negative X-axis direction is generated, and detection data shown in FIG. 5B is output from the detecting unit 60. In this case, the command generating unit 192 detects in the detection data from the detecting unit 60 that the acceleration in the negative X-axis direction exceeds the predetermined threshold value TH once, and generates a command corresponding to one impact in the negative X-axis direction assuming that there is one impact in the negative X-axis direction.

Moreover, in FIG. 4, when user taps a front side A3 of the image display unit 20 with his/her finger only once from a direction indicated by V3 in the drawing, acceleration in the positive Z-axis direction is generated, and detection data shown in FIG. 5C is output from the detecting unit 60. In this case, the command generating unit 192 detects in the detection data from the detecting unit 60 that the acceleration in the positive Z-axis direction exceeds the predetermined threshold value TH once, and generates a command corresponding to one impact in the positive Z-axis direction assuming that there is one impact in the positive Z-axis direction.

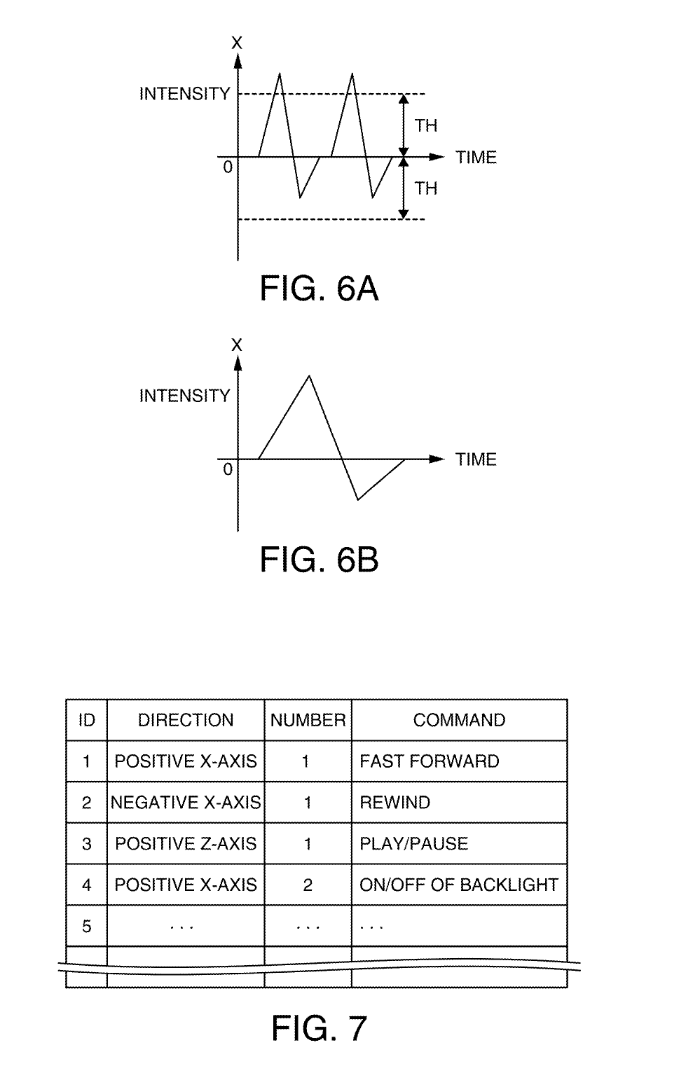

Moreover, in FIG. 4, when user taps the right-side end portion A1 of the right optical image display unit 26 twice in a row from the direction indicated by V1 in the drawing, acceleration in the positive X-axis direction is generated, and detection data shown in FIG. 6A is output from the detecting unit 60. In this case, the command generating unit 192 detects in the detection data from the detecting unit 60 that the acceleration in the positive X-axis direction exceeds the predetermined threshold value TH twice in the predetermined time, and generates a command corresponding to two impacts in the positive X-axis direction assuming that there are two impacts in the positive X-axis direction.

In this manner, in the head-mounted display device 100 of the embodiment, the user performs an operation of tapping the image display unit 20 with his/her finger from any direction and any number of times in the state where the user wears the image display unit 20 on the head, so that the user can input a command that is different according to the direction and number of times of tapping. Therefore, compared to the case of operating a button or the like disposed in a controller, the device operation of the head-mounted display device 100 can be easily performed.

In the embodiment, an acceleration sensor is used as the detecting unit 60. Therefore, also when the user wearing the image display unit 20 on the head performs an action of displacing the head (for example, an action of turning around), acceleration is detected in the detecting unit 60. In this case, as shown in FIG. 6B, the waveform of the acceleration detected in the detecting unit 60 is broad (the wavelength of the waveform of the acceleration is large).

Accordingly, the command generating unit 192 may be configured such that only if the wavelength of an acceleration waveform based on detection data from the detecting unit 60 is smaller than a predetermined threshold value, the command generating unit 192 generates the corresponding command, and that if the wavelength of the acceleration waveform based on detection data from the detecting unit 60 is larger than the predetermined threshold value, the command generating unit 192 determines that there is no impact on the image display unit 20 (an operation of tapping the image display unit 20 with a finger), and does not generate a command. Moreover, the command generating unit 192 may be configured such that when the detecting unit 60 includes an acceleration sensor and an angular velocity sensor, if displacement of the head is detected based on detection data from the angular velocity sensor, the command generating unit 192 determines that there is no impact on the image display unit 20, and does not generate a command. By doing this, an impact on the image display unit 20 and displacement of the head of the user wearing the image display unit 20 can be differentiated from each other to reliably detect an operation of tapping the image display unit 20 with a finger.

FIG. 7 shows an example of commands each allocated to the direction and number of impacts detected in the detecting unit 60. In the example shown in FIG. 7, command IDs “1” to “3” are allocated to commands to perform control of the application for reproducing a moving image and sound installed in the OS 150, and a command ID “4” is allocated to a command to perform display control (control of adjusting the luminance of image light) with the display control unit 190. Any allocation of commands is possible, and a configuration may be made such that the user can set the allocation of commands.

That is, in the example shown in FIG. 7, if detecting one impact in the positive X-axis direction based on detection data from the detecting unit 60, the command generating unit 192 generates a command to allow the application for reproducing a moving image and sound to execute “fast forward”. If detecting one impact in the negative X-axis direction, the command generating unit 192 generates a command to allow the application for reproducing a moving image and sound to execute “rewind”. If detecting one impact in the positive Z-axis direction, the command generating unit 192 generates a command to allow the application for reproducing a moving image and sound to execute “play” or “pause”. That is, during execution of the application for reproducing a moving image and sound, the user can perform a “fast forward” operation by tapping once the right-side end portion of the right optical image display unit 26. The user can perform a “rewind” operation by tapping once the left-side end portion of the left optical image display unit 28. The user can perform a “play” or “pause” operation by tapping once the front side of the image display unit 20.

Moreover, in the example shown in FIG. 7, if detecting two impacts in the positive X-axis direction based on detection data from the detecting unit 60, the command generating unit 192 generates a command to allow the display control unit 190 to execute control of turning on or off the driving of the right backlight 221 and the left backlight 222. When the control of turning on the driving of the right backlight 221 and the left backlight 222 is executed, it is possible to allow the user to visually recognize the virtual image VI and the outside scene SC (outside world image) in the state where they are superimposed on each other. When the control of turning off the driving of the right backlight 221 and the left backlight 222 is executed, the luminance of image light is lowered to allow the user to visually recognize only the outside scene SC. That is, in a mode where the virtual image VI and the outside scene SC are visually recognized in the state where they are superimposed on each other, the user can switch to a mode where only the outside scene SC is visually recognized by tapping twice the right-side end portion of the right optical image display unit 26. Moreover, in the mode where only the outside scene SC is visually recognized, the user can switch to the mode where the virtual image VI and the outside scene SC are visually recognized in the state where they are superimposed on each other by tapping twice the right-side end portion of the right optical image display unit 26. In this manner, the user can easily perform the operation of switching between the mode where the virtual image VI is visually recognized preferentially and the mode where the outside scene SC is visually recognized preferentially.

When the command to allow the display control unit 190 to execute the control of turning off the driving of the right backlight 221 and the left backlight 222 is generated, the sound processing unit 170 may be simultaneously allowed to execute control of muting sound. When the command to allow the display control unit 190 to execute the control of turning on the driving of the right backlight 221 and the left backlight 222 is generated, the sound processing unit 170 may be simultaneously allowed to execute control of regaining sound.

### 3. Modified Example

The invention is not limited to the embodiment described above but can be variously modified. For example, the invention includes a configuration (for example, a configuration having the same function, method, and result, or a configuration having the same advantage and effect) which is substantially the same as those described in the embodiment. Moreover, the invention includes a configuration in which a non-essential portion of the configurations described in the embodiment is replaced. Moreover, the invention includes a configuration providing the same operational effects as those described in the embodiment, or a configuration capable of achieving the same advantages. Moreover, the invention includes a configuration in which a publicly known technique is added to the configurations described in the embodiment.

For example, in the embodiment, a case has been described in which the control unit 10 and the image display unit 20 are separately configured. However, the control unit 10 and the image display unit 20 may be integrated to constitute the head-mounted display device 100. Moreover, in the embodiment, a case has been described in which the detecting unit 60 is disposed in the image display unit 20. However, the detecting unit 60 may be disposed in the control unit 10. In this case, the user can perform a command input by performing an operation such as tapping with his/her finger the control unit 10 including the detecting unit 60 from any direction and any number of times, or a simple operation such as shaking or turning the control unit 10 including the detecting unit 60, so that the device operation of the head-mounted display device 100 can be easily performed. For example, by configuring the control unit 10 including the detecting unit 60 as a watch-type controller, the operation described above can be easily performed. Moreover, the control unit 10 including the detecting unit 60 may be configured to be detachable to the image display unit 20. In this case, a command input can be performed by performing an operation (an operation of tapping the image display unit 20 with a finger) similar to that of the embodiment in a state where the control unit 10 including the detecting unit 60 is attached to the image display unit 20.

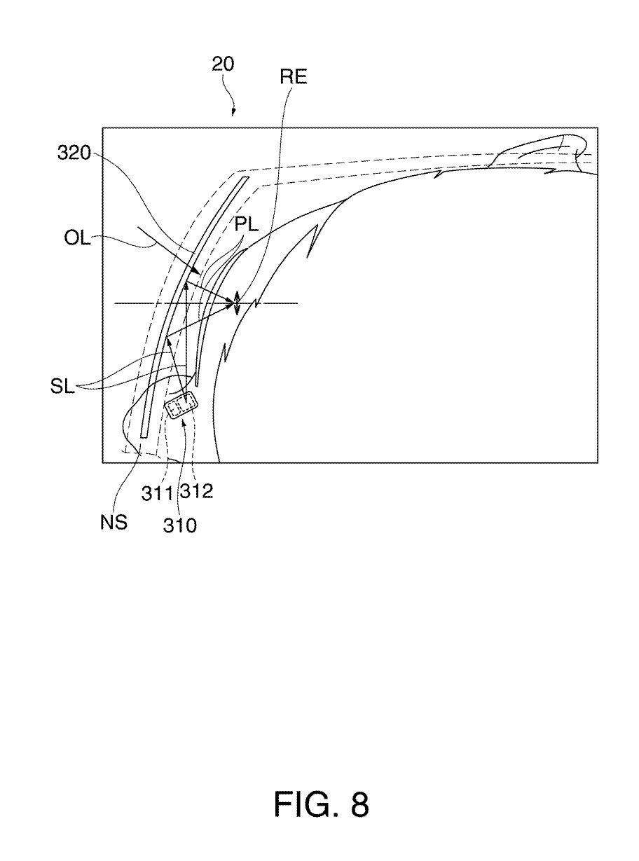

Moreover, in the embodiment, a case has been described in which the image light generating unit includes the liquid crystal panel and the backlight and image light generated is guided to the eyes of the user by the light guide unit. However, the invention is not limited to this. For example, as shown in FIG. 8, the image light generating unit (the image display unit 20) may include a light emitting unit 310 that forms signal light and emits the signal light as scanning light SL and a virtual image forming unit 320 that is an irradiated member receiving the scanning light SL to form image light PL. As shown in FIG. 8, the light emitting unit 310 is arranged around a nose NS of the user, while the virtual image forming unit 320 is arranged so as to cover the front of the eye RE of the user. The light emitting unit 310 has a signal light modulating unit 311 that forms signal light, a scanning optical system 312 that performs two-dimensional scanning in the virtual image forming unit 320 using the signal light as the scanning light SL, and a drive control circuit (not shown). The signal light modulating unit 311 includes, for example, three light sources that generate respective red, blue, and yellow color lights and a dichroic mirror that combines the respective color lights to form signal light. The scanning optical system 312 includes, for example, a MEMS mirror. The virtual image forming unit 320 is a half mirror that is configured to have a semi-transmissive reflecting layer on a transparent substrate. The virtual image forming unit 320 receives the scanning light SL irradiated from the scanning optical system 312 and reflects the scanning light SL to form a virtual image, thereby allowing the user to visually recognize the virtual image. The virtual image forming unit 320 is configured such that the virtual image forming unit 320 not only forms a virtual image but also transmits outside world light OL to make it possible for the user to visually recognize the virtual image and an outside world image simultaneously.

The entire disclosure of Japanese Patent Application No. 2012-064730, filed Mar. 22, 2012 is expressly incorporated by reference herein.

What is claimed is:

1. A head-mounted display device comprising:
an image display unit including an image light generating unit that generates image light representing an image, and allowing a user to visually recognize a virtual image in a state where the image display unit is mounted on the head of the user;
a detecting unit that detects at least one of an impact and displacement; and
a control unit that generates a given command based on detection data detected in the detecting unit.

2. The head-mounted display device according to claim 1, wherein
the detecting unit is disposed in the image display unit.

3. The head-mounted display device according to claim 1, wherein
the image display unit is configured such that the user can visually recognize the virtual image and an outside world image simultaneously, and
the control unit controls, based on detection data detected in the detecting unit, image display with the image light generating unit to adjust the luminance of the image light.

4. The head-mounted display device according to claim 3, wherein
the control unit performs, based on detection data detected in the detecting unit, control of switching between a mode where the user is allowed to visually recognize the virtual image and an outside world image simultaneously and a mode where the luminance of the image light is lowered to allow the user to visually recognize the outside world image preferentially.

5. The head-mounted display device according to claim 1, wherein
the control unit generates the command based on at least one of the number and direction of impacts detected in the detecting unit.

6. The head-mounted display device according to claim 1, wherein
the detecting unit includes a plurality of sensors that detect at least one of an impact and displacement.

7. The head-mounted display device according to claim 1, wherein
the detecting unit includes an acceleration sensor and an angular velocity sensor.

8. The head-mounted display device according to claim 1, wherein
the control unit is disposed in the image display unit.
